(19) United States
(12) Patent Application Publication
(10) Pub. No.: US 2024/0333839 A1
(43) Pub. Date: Oct. 3, 2024

(54) SCALABILITY FOR ONLINE DISCUSSION FORUMS

(71) Applicant: Alpha Exploration Co. d/b/a Clubhouse, San Francisco, CA (US)

(72) Inventors: Paul DAVISON, San Francisco, CA (US); Rohan SETH, San Francisco, CA (US); Patrick UNDERWOOD, San Francisco, CA (US); Molly NIX, San Francisco, CA (US); Mohammad ALMALKAWI, San Francisco, CA (US); Daniel HAMMOND, San Francisco, CA (US); Kenny D'AMICA, San Francisco, CA (US); Chris GALLELLO, San Francisco, CA (US)

(73) Assignee: Alpha Exploration Co. d/b/a Clubhouse, San Francisco, CA (US)

(21) Appl. No.: 18/620,079

(22) Filed: Mar. 28, 2024

Related U.S. Application Data
(60) Provisional application No. 63/455,102, filed on Mar. 28, 2023.

(51) Int. Cl. H04M 3/56; G06F 3/16; H04L 65/1096

(52) U.S. Cl. CPC H04M 3/568; G06F 3/165; H04L 65/1096; H04M 2201/40; H04M 2203/305

(57) ABSTRACT

An asynchronous audio discussion system may provide a set of users with access to an asynchronous audio discussion forum, receive first voice data at a first time, and receive second voice data at a second time that is later than the first time. The asynchronous audio discussion system may generate a first voice entry based on the first voice data and a second voice entry based on the second voice data. The asynchronous audio discussion system may provide, within the asynchronous audio discussion forum, the first voice entry and the second voice entry for playback by one or more users included in the set of users.

### CROSS-REFERENCE TO RELATED APPLICATIONS

This application claims the benefit of U.S. Provisional Application No. 63/455,102, filed 28 Mar. 2023, which is incorporated herein by reference in its entirety. This specification contains subject matter related to U.S. Provisional Application No. 63/356,344, filed 28 Jun. 2022, and U.S. Provisional Application No. 63/327,635, filed 5 Apr. 2022, each of which is incorporated herein by reference in its entirety.

### BACKGROUND

Online audio-based discussions refer to conversations or interactions that take place over a network connection (e.g., a wired or wireless network connection) using audio as a primary medium of communication. These discussions can occur in various formats, ranging from informal voice chats between friends to structured audio conferences involving multiple participants discussing specific topics.

### SUMMARY

Some implementations described herein relate to a method comprising: generating, by a device, an asynchronous audio discussion forum, wherein a set of users has access to the asynchronous audio discussion forum; receiving, by the device and at a first time, first voice data; receiving, by the device and at a second time that is later than the first time, second voice data; generating, by the device, a first voice entry based on the first voice data and a second voice entry based on the second voice data; and providing, by the device and within the asynchronous audio discussion forum, the first voice entry and the second voice entry for playback by one or more users included in the set of users.

Some implementations described herein relate to a system, comprising: one or more memories; and one or more processors, communicatively coupled to the one or more memories, configured to: provide a set of users with access to an asynchronous audio discussion forum; receive first voice data at a first time; receive second voice data at a second time that is later than the first time; generate a first voice entry based on the first voice data and a second voice entry based on the second voice data; and provide, within the asynchronous audio discussion forum, the first voice entry and the second voice entry for playback by one or more users included in the set of users.

Some implementations described herein relate to a non-transitory computer-readable medium that stores a set of instructions for an asynchronous audio discussion system. The set of instructions, when executed by one or more processors of the asynchronous audio discussion system, may cause the asynchronous audio discussion system to provide a set of users with access to an asynchronous audio discussion forum; receive first voice data at a first time; receive second voice data at a second time that is later than the first time; generate a first voice entry based on the first voice data and a second voice entry based on the second voice data; and provide, within the asynchronous audio discussion forum, the first voice entry and the second voice entry for playback by one or more users included in the set of users.

### BRIEF DESCRIPTION OF THE DRAWINGS

FIG. 1 illustrates a block diagram of a system for providing online audio discussion forums in accordance with aspects described herein.

FIG. 2 illustrates a block diagram of an audio service arrangement in accordance with aspects described herein.

FIG. 3 illustrates a block diagram of an audio processing architecture in accordance with aspects described herein.

FIG. 4 illustrates a flow diagram of a method of a user creating a group discussion in accordance with aspects described herein.

FIG. 5 illustrates a flow diagram of a method of a user listening to voice entries and creating a new voice entry in accordance with aspects described herein.

FIG. 6 illustrates an example computing device.

FIGS. 7A-7M illustrate exemplary screen shots of user interfaces in accordance with aspects described herein.

### DETAILED DESCRIPTION

The following detailed description of example implementations refers to the accompanying drawings. The same reference numbers in different drawings may identify the same or similar elements.

Online audio-based (e.g., voice-based) discussions typically require each person involved to be online together at the same time and to devote a certain time to the online audio-based conversations. These time commitments, especially for groups of participants, can be challenging and wasteful. For example, some participants may not need to contribute by voice but need to have access to the full discussion. As another example, other participants may have a needed contribution, but are unavailable during the allotted time for the voice-based conversation. Still other participants may only need to hear contributions of certain participants (e.g., speakers of the voice-based conversations). As recognized by the present inventors, it would therefore be desirable to provide an

Some implementations described herein enable online audio-based discussions that accommodate varying time needs of users (e.g., participants) and that accommodate varying contribution obligations of the users, as described in more detail elsewhere herein. As an example, a system (e.g., an asynchronous audio discussion system) may generate an asynchronous audio discussion forum. A set of users may have access to the asynchronous audio discussion forum where one or more users, included in the set of users, may participate in an asynchronous audio discussion (e.g., an asynchronous voice conversation, as described in more detail elsewhere herein).

In some implementations, the system may receive asynchronous voice data. As an example, the system may receive voice data from multiple users, included in the set of users, at different times. The system may generate voice entries based on the voice data (e.g., the system may store the voice data as voice entries and may associate the voice entries with data and/or metadata, as described in more detail elsewhere herein). As an example, a first user may provide, and the system may receive, first voice data at a first time and second voice data at a second time that is later than the first time. The system may generate a first voice entry based on the first voice data and a second voice entry based on the second voice data. The system may provide, within the asynchronous audio discussion forum, the first voice entry and the second voice entry for playback.

A third user, included in the set of users, may cause playback of the first voice entry and/or the second voice entry. The third user may provide, and the system may receive, third voice data. The system may generate a third voice entry based on the third voice data, which may be responsive to the first voice entry and/or the second voice entry. The system may add the third voice entry to the asynchronous audio discussion forum for payback by the one or more users included in the set of users.

In this way, the set of users included in the asynchronous audio discussion forums (e.g., the set of users having access to the asynchronous audio discussion forums) may participate in asynchronous audio discussions at any suitable time (e.g., by providing voice data and/or by listening to voice entries included in the asynchronous audio discussion forums, among other examples).

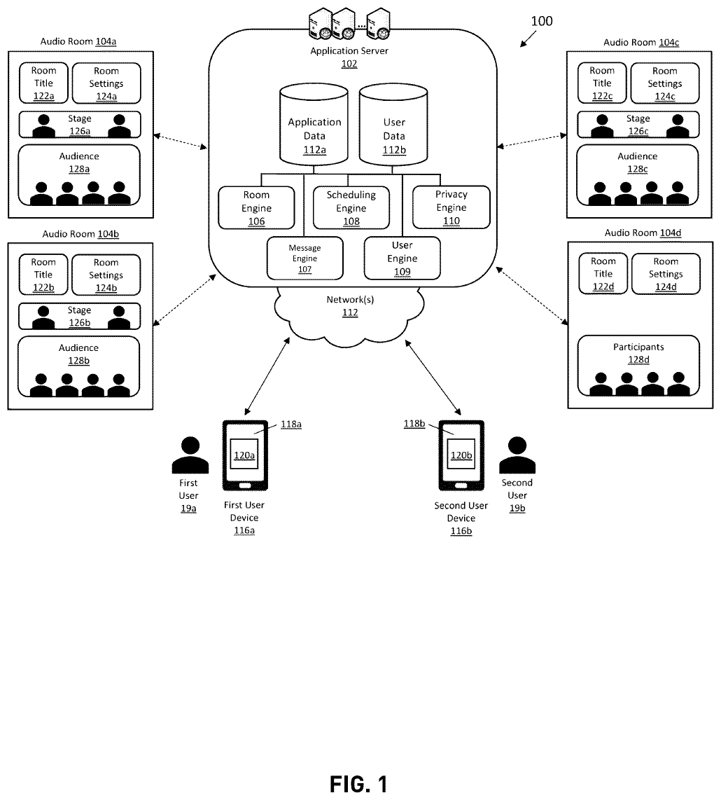

FIG. 1 is a block diagram of a system 100 for providing asynchronous audio discussion forums, which may also be referred herein as audio rooms. In some implementations, the system 100 may be implemented by an application server 102. The application server 102 may provide functionality for creating and providing one or more audio rooms (e.g., shown as audio rooms 104a, 104b, 104c, and 104d in FIG. 1). The application server 102 may include software components and databases that may be deployed at one or more data centers (not shown), such as databases that may be deployed in one or more geographic locations, among other examples.

As shown in FIG. 1, the software components (e.g., of the application server 102) include a room engine 106, a message engine 107, a scheduling engine 108, a user engine 109, and a privacy engine 110. The software components may include subcomponents that execute on a same, or a different, data processing apparatus. The databases (e.g., of the application server 102) may include an application database (e.g., shown as application data 112a in FIG. 1) and a user database (e.g., shown as user data 112b in FIG. 1). The databases may reside in one or more physical storage systems.

In some implementations, the application server 102 may send and receive data (including audio data or voice data, among other examples) to and from devices (e.g., to and from client devices and/or user devices, among other examples) through one or more data communication networks (e.g., shown as network 112 in FIG. 1), such as the Internet.

As shown in FIG. 1, a first user 19a may access, via a first user interface 120a of a first user device 116a, a first client application 118a (e.g., a web browser or a special-purpose software application executing on the first user device 116a) that provides access to one or more of the audio rooms 104a, 104b, 104c, and 104d, which are implemented by the application server 102. Similarly, a second user 19b may access, via a second user interface 120b of a second user device 116b, a second client application 118b (e.g., a web browser or a special-purpose software application executing on the second user device 116b) that provides access to one or more of the audio rooms 104a, 104b, 104c, and 104d, which are implemented by the application server 102. In some implementations, the first user interface 120a may be substantially similar to, or the same as, the second user interface 120b, and the first client application 118a may be substantially similar to, or the same as, the second client application 118b. In some implementations, the first client application 118a and the second client application 118b may provide, or display, user-specific content, as described in more detail elsewhere herein.

Although the application server 102 is described as performing operations in connection with FIG. 1, and/or as described in more detail elsewhere herein, other devices may perform the operations performed by the application server 102. For example, some or all functions performed by application server 102 may be performed locally by a client application (e.g., the first client application 118a and/or the second client application 118b, among other examples). The client application may communicate with the application server 102 (e.g., over the network 112) using a communication protocol and/or communication technique (e.g., a Hypertext Transfer Protocol (HTTP) and/or a proprietary protocol, among other examples).

The client device (e.g., the first user device 116a and/or the second user device 116b, among other examples) may be a mobile phone, a smart watch, a tablet computer, a personal computer, a game console, and/or or an in-car media system, among other examples.

In some implementations, the system 100 enables asynchronous audio discussions between users in virtual asynchronous audio discussion forums (e.g., the audio rooms 104a, 104b, 104c, and/or 104d, among other examples). As shown, each of the audio rooms 104a, 104b, 104c, and 104d include a room title (e.g., shown as room titles 122a, 122b, 122c, and 122d in FIG. 1), room settings (e.g., shown as room settings 124a, 124b, 124c, and 124d in FIG. 1), a stage (e.g., shown as stages 126a, 126b, 126c, and 126d), and an audience (e.g., shown as audiences 128a, 128b, 128c, and participants 128d in FIG. 1).

In some implementations, the room title may correspond to a pre-determined topic or subject of the discussion within each audio room. The users in each audio room may be grouped as speakers or audience members (e.g., listeners). As an example, the users included in the audio rooms may be assigned a speaker status (e.g., a speaker permission status) or a non-speaker status (e.g., a listener permission status). The speaker status enables users to provide voice data while the non-speaker status disables users from being able to provide voice data, as described in more detail elsewhere herein. In other words, users having a speaker status may provide voice data and listen to voice entries and users having a non-speaker status cannot provide voice data but can listen to voice entries.

In some implementations, voice data (e.g., provided by users) may be created using a text-to-speech voice generation technique, which may include using one or more voice cloning techniques. Users may create a custom voice that emulates their real speaking voice (or another voice) to use when responding to voice entries. In this way, users may use text-based inputs that are translated into voice data to create voice entries.

In some implementations, users may navigate between various audio rooms and may participate as speakers and/or audience members via the client application. For example, the first user 19a may use the first user device 116a, the first client application 118a, and the first user interface 120a to cause a new audio room to be created. The first user 19a may provide input indicating whether the first user 19a is a speaker or a non-speaker, a room title, and/or room settings, among other examples.

In some implementations, the first user 19a may invite the second user 19b (or any other user) to join the new audio room (e.g., the audio room 104a) as a speaker or as a non-speaker (e.g., a member of the audience 128a). The second user 19b may gain access to the new audio room (e.g., by accepting the invitation to join the new audio room). In this way, the first user 19a and the second user 19b may use the new audio room to engage in asynchronous audio discussions.

As an example, the first user 19a may provide first voice data. The application server 102 may generate a first voice entry (e.g., the application server 102 may store the first voice data as the first voice entry and may associated the first voice entry with data and/or metadata, as described in more detail elsewhere herein). The second user 19b may cause playback of the first voice entry. The second user 19b may provide second voice data (e.g., in response to the first voice entry). The application server 102a may generate a second voice entry and may provide the second voice entry for playback in the new audio room. The first user may cause playback of the second voice entry. In other words, the first user 19a and the second user 19b may engage in asynchronous discussions because the first user 19a and the second user 19b do not need to actively participate in the asynchronous audio discussions in real time (or near real time). Additionally, or alternatively, the application server 102 may provide notifications to the users (e.g., the first user 19a and the second user 19b) based on additional voice entries (e.g., based on voice data from one or more users with access to the new audio room). In this way, users having access to the new audio room may listen to voice entries on their own time, receive notifications when new entries have been received, and/or contribute their own voice entries (e.g., in response to one or more voice entries), among other examples. The first user 19a and/or the second user 19b may also join different audio rooms (e.g., if the first user 19a and the second user 19b have corresponding access to the different audio rooms). Furthermore, the first user 19a and/or the second user 19b may cause a new audio room to be created, as described in more detail elsewhere herein.

The room engine 106 (e.g., of the application server 102) may generate and/or modify the audio rooms. For example, the room engine 106 may establish the room titles and the room settings of the audio rooms based on user input provided via the client application and/or user based on preferences saved in the user database. In some implementations, users may transition from speaker to audience member, or vice versa, within an audio room. Accordingly, the room engine 106 may be configured to dynamically transfer speaking privileges between users at any suitable time during the asynchronous audio discussions. In some implementations, the audio rooms may be launched by the room engine 106 and hosted on the application server 102; however, in some other implementations, the audio rooms may be hosted on a different server (e.g., an audio room server, among other examples).

The message engine 107 may provide messaging functions such that users can communicate on the platform (e.g., outside of audio rooms). In some implementations, the message engine 107 may enable text-based and/or image-based (e.g., images and/or video) messaging between users. The message engine 107 may allow users to communicate in user-to-user chat threads and/or group chat threads (e.g., between three or more users).

The scheduling engine 108 may schedule generation (e.g., by the room engine 106) of audio rooms. For example, the scheduling engine 108 may establish parameters (e.g., a room title and/or room settings based on user input, among other examples) for an audio room to be generated at a future time. In some implementations, the parameters may be stored in the application database until the scheduled date/time associated with audio room to be generated. In some implementations, the application database may store the parameters until the audio room is accessed by a user having access to the audio room.

The user engine 109 may manage user relationships. For example, the user engine 109 may access the user data 112b to compile lists (e.g., lists of users that are associates and/or that “follow” one another, among other examples). In some implementations, the user engine 109 may monitor and determine the status of a user. For example, the user engine 109 may determine which users are online (e.g., actively using the platform) at any given time. In some implementations, the user engine 109 may monitor a state of the client application on the user device (e.g., an active state or a background state, among other examples).

The privacy engine 110 may establish privacy (or visibility) settings of the audio rooms. The privacy settings of each audio room may be included as part of the room settings. In some implementations, the privacy settings may correspond to a visibility level of the audio room. For example, each audio room may have a visibility level (e.g., open, social, or closed, among other examples) that determines which users can join the audio room. In some implementations, the visibility level of the audio room may change based on a current speaker in the audio room and/or based on behavior of users in the audio room, among other examples. Additionally, or alternatively, the privacy engine 110 may dynamically adjust the visibility level of the audio room. In some implementations, the privacy engine 110 may suggest visibility level adjustments (or recommendations) to one or more speakers in the audio room.

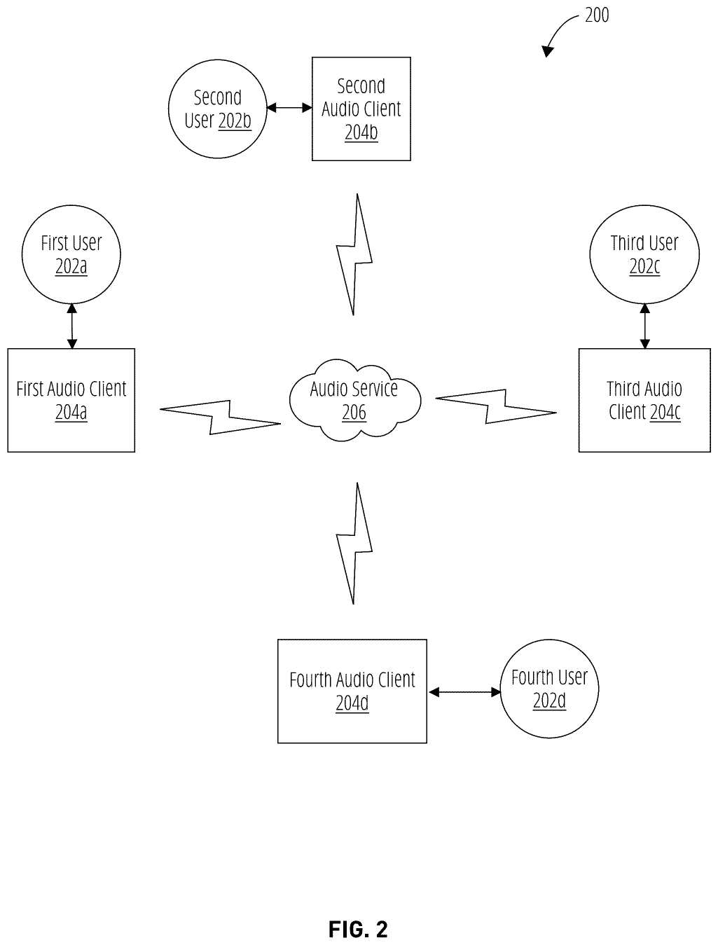

FIG. 2 is a block diagram of an audio service arrangement 200 in accordance with aspects described herein. The audio service arrangement 200 represents a flow of audio data (e.g., voice data) within an audio room (e.g., the audio rooms 104a, 104b, 104c, and 104d). In some implementations, the audio service arrangement 200 includes a plurality of users (e.g., shown as a first user 202a, a second user 202b, a third user 202c, and a fourth user 202d), a plurality of audio clients 204 (e.g., shown as a first audio client 204a, a second audio client 204b, a third audio client 204c, and a fourth audio client 204d in FIG. 2), and an audio service 206. The plurality of users may include any suitable number of users.

In some implementations, each audio client, of the plurality of audio clients, is included in a client application (e.g., the first client application 118a or the second client application 118b) running on a user device (e.g., the first user device 116a or the second user device 116b). In some implementations, the audio service 206 may be included as an application or may be included in an engine on the application server 102; however, in other examples, the audio service 206 may be included as an application or engine on any suitable server.

In some implementations, the audio client for each speaker in the audio room publishes the voice data (e.g., which is received as a microphone input) from the corresponding user to the audio service 206. The audio service 206 may transmit the received voice data to the audio client of each member of the audio room (e.g., other than the user who provided the voice data). As an example, the first user 202a and the second user 202b may be speakers (e.g., based on speaker statuses) and the third user 202c and the fourth user 202d may be non-speakers (e.g., or audience members or listeners based on non-speaker statuses, among other examples).

As an example, the first user 202a may provide, via the first audio client 204a, voice data corresponding to the first user 202a, which is received by the audio service 206. The audio service 206 may direct the voice data to the second audio client 204b, the third audio client 204c, and the fourth audio client 204d. As another example, the second user 202b may provide, via the second audio client 204b, voice data corresponding to the second user 202b, which is received by the audio service 206.

The audio service 206 may direct the voice data to the first audio client 204a, the third audio client 204c, and the fourth audio client 204d. In addition to forwarding received voice data from one user to another (e.g., via the client devices), the audio service 206 may store the voice data in a storage, such as a memory, a hard drive, a cloud storage, or other storage device capable of storing voice data, among other examples. The voice data may be stored with data and/or metadata that includes identification information for retrieving and providing the voice data to persons included in the discussion (e.g., the first user 202a, the second user 202b, the third user 202c, and/or the fourth user 202d) and/or for providing voice entries within the asynchronous audio discussion forums.

In some implementations, the data and/or the metadata may indicate an identification of a user that created the voice data, an identification of the asynchronous audio discussion forum associated with the voice data, a time and a date that the voice data was created, a time and a date that the voice data was received, a time and a date that the voice data was entered within the asynchronous audio discussion forum as a voice entry, a duration, or length, of the voice data, a duration or length of the voice entry, and/or any other information suitable information (e.g., information that may be used to identify and retrieve voice data and/or voice entries for users with access to the asynchronous audio discussion forum).

In some implementations, a centralized nature of the audio service arrangement 200 can lead to performance issues (e.g., when scaling to meet the demands of larger audio rooms and more users). As more users (e.g., audience members or speakers) join the audio room 104, a number of connections to the audio service 206 increases. As such, the audio service 206 is used for transmitting voice data to an increasing number of audio clients. The audio clients (e.g., of the users) may be spread out in different geographical locations relative to a machine hosting the audio service 206. In such cases, latencies can become unacceptably large depending on the physical locations of the users relative to the machine hosting the audio service 206. Additionally, a different latency may be associated with transmitting and receiving voice data from each audio client. Different latencies can cause lags or delays that disrupt the asynchronous audio discussion forum. As larger numbers of users join the audio room, the server hosting the audio service 206, or the computing resources dedicated to the audio service 206, may become overloaded, which is typically referred to as hot spotting. Furthermore, the audio clients may be connected to the audio service 206 with different types of network connections (e.g., Wi-Fi, 5G, or 4G, among other examples) and speeds (e.g., 1 Mbps, 100 Mbps, or 1000 Mbps, among other examples).

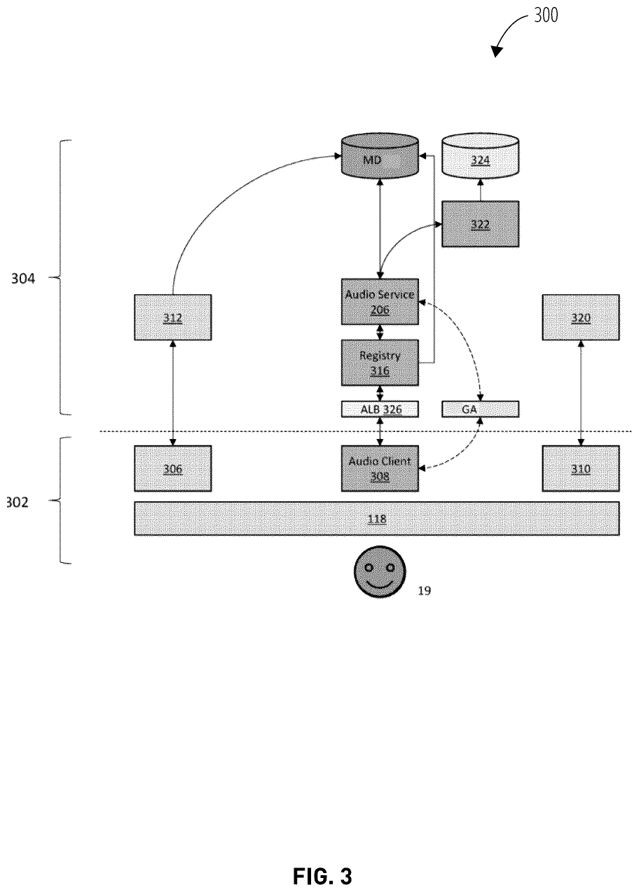

FIG. 3 is a block diagram of an audio processing architecture 300 in accordance with aspects described herein. The audio processing architecture 300 includes a local environment 302 (e.g., which may correspond to the first user device 116a of the first user 19a or the second user device 116b of the second user 19b, among other examples) and a remote environment 304 (e.g., which may correspond to a cloud or server-based environment, such as the application server 102, among other examples). It should be appreciated that the remote environment 304 may include multiple remote environments hosted on servers located in different geographical locations.

In some implementations, the local environment 302 includes a client application (e.g., the first client application 118a or the second client application 118b), a backend client 306, an audio client 308 (e.g., the first audio client 204a, the second audio client 204b, the third audio client 204c, and/or the fourth audio client 204d), and a real-time communication (RTC) client 310. In some implementations, the backend client 306, the audio client 308, and the RTC client 310 may be included in the client application. In other implementations, the backend client 306, the audio client 308, and/or the RTC client 310 may be external software modules that communicate with the client application.

The remote environment 304 includes a backend service 312, a mapping database 314, a registry 316, an audio service (e.g., the audio service 206), and an RTC service 320. The remote environment 304 includes a recorder 322 and an audio room database 324. In some implementations, the audio processing architecture 300 enables the audio client 308 to maintain a long-lived remote procedure call (RPC) signaling connection (e.g., a gRPC connection) and a long-lived RTC media connection (e.g., a WebRTC connection) to a geographically local media router (e.g., the audio service 206).

In some implementations, data traffic (e.g., voice data and/or voice entries) may be delivered to users via multiplexing techniques over these connections. The RPC signaling connection may be used by the audio client 308 to establish a connection to the audio service and to initialize the RTC media connection. In some implementations, the RPC connection is a streaming connection that allows messages to be pushed bidirectionally. In addition to controlling the RTC connection, the RPC connection may be used to track users joining and/or leaving the audio room.

In some implementations, the RTC protocols (e.g., secure real-time transport protocols (SRTPs), among other examples), are used for media. In some implementations, the RTC protocols may be used rather than HTTP protocols because of the real-time nature (or near real-time nature) of the application (e.g., asynchronous audio discussions). The registry 316 acts as a frontend for the audio processing architecture 300. The registry 316 maintains minimal state and may be located near the audio client 308 (e.g., the registry 216 may be an edge device). The audio client 308 may communicate with the registry 316 via an application load balancer (ALB) 326. In some implementations, a list of speakers for each audio room is stored in the mapping database 314.

The backend service 312 may provide updates (e.g., periodic updates) to the speaker lists stored in the mapping database 314. In some examples, the backend service 312 may receive updates corresponding to each user from the backend client 306. For example, the backend client 306 may push updates to the backend service 312 each time a status of a user changes (e.g., from speaker to audience member, or vice versa) in an audio room. As an example, to change a status of a user from an audience member to a speaker), the audio room client 308 may request speaker tokens from the backend service 312.

In some implementations, the recorder 322 may be used for recording the voice data (e.g., provided by the users via the client devices). As an example, the recorder 322 may receive voice data and may store the voice data in a storage device such as a memory, a hard drive, a cloud storage, or other storage device capable of storing voice data, among other examples. Data and/or metadata associated with the voice data may be stored in the audio room database 324.

In some implementations, the data and/or the metadata may indicate an identification of a user that created the voice data, an identification of the asynchronous audio discussion forum associated with the voice data, a time and a date that the voice data was created, a time and date that the voice data was received, a time and a date that the voice data was entered within the asynchronous audio discussion forum as a voice entry, a duration or a length of the voice data, a duration or length of the voice entry, and/or any other information suitable information (e.g., information that may be used to identify and retrieve voice data for users with access to the asynchronous audio discussion forum). The recorded voice data from the asynchronous audio discussion may be accessed via a client application for playback (e.g., as voice entries), as described in more detail elsewhere herein. In some implementations, the backend client 306 and the backend service 312 may correspond to a backend framework (e.g., a Django web framework), and the RTC client 310 and the RTC service 320 may correspond to a communication platform framework (e.g., PubNub).

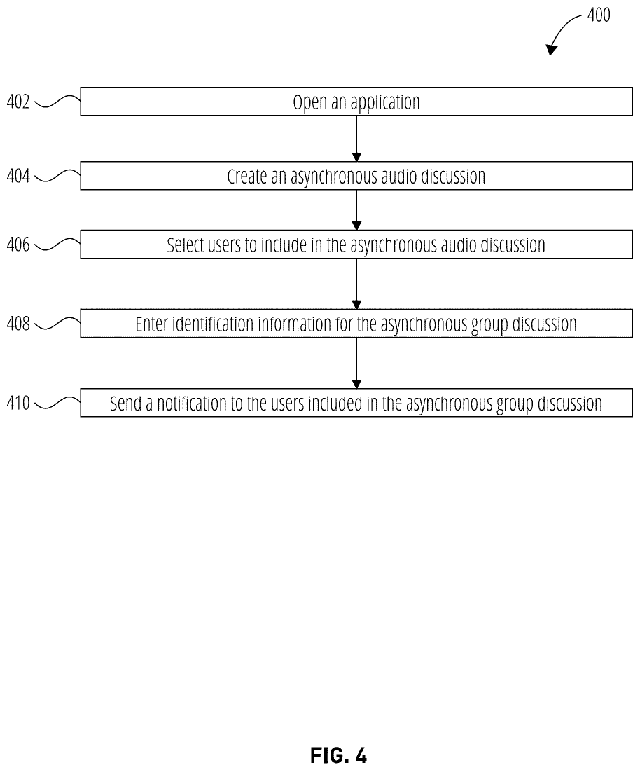

FIG. 4 is a flowchart of an example process 400 associated with asynchronous audio discussions. In some implementations, the process 400 may be implemented via the audio processing architecture 300 of FIG. 3. As described herein, “group” refers to a collection of people (e.g., users) who have access to a conversation that happens asynchronously (e.g., via access to an asynchronous audio discussion forum). In this way, users included in the group (e.g., a set of users) need not be simultaneously present (e.g., physically or virtually) to add a voice entry (e.g., by providing voice data in response to other voice entries). In some implementations, users included in the group may have different permissions, such as speaker permission statuses or non-speaker statuses, as described in more detail elsewhere herein.

As shown in FIG. 4, the process 400 includes opening an application (block 402). As an example, a user may open a client application (e.g., the first user 19a may open the first client application 118a). As shown in FIG. 4, the process 400 includes creating an asynchronous audio discussion forum (block 404). As an example, after the client application is opened, the client application may present options for selection by the user. The options for selection may include an option to create a new asynchronous audio discussion forum and/or an option to select an asynchronous audio discussion forum from a list of asynchronous audio discussion forums.

As shown in FIG. 4, the process 400 includes selecting users to include in the asynchronous audio discussion forum (block 406). As an example, the client application may present a list of users to the user, and the user may select the users to include in the asynchronous audio discussion forum. The selected users have access to the asynchronous audio discussion forum.

In some implementations, the user may select the users from a list of friends, a list of followers, a contact list, a list of users who participated in previous asynchronous audio discussions, and/or a list of users associated with a different application or platform, among other examples. Additionally, or alternatively, the user may select the users to include in the asynchronous audio discussion forum by entering identification information for each user, such as a username, an email address, or some other unique identifier, among other examples.

In some implementations, the users with access to the asynchronous audio discussion forum may be determined by a context of an application (e.g., if the asynchronous audio discussion forum is created within a section of an application dedicated to a specific group of users, the access may automatically be granted to all users in that group specific group) or can default to a specific access setting (e.g., all users can access), among other examples.

As shown in FIG. 4, the process 400 includes entering identification information for the asynchronous audio discussion forum (block 408). As an example, the user may provide a room title, room settings, a topic for discussion, and/or an image or an icon associated with the asynchronous audio discussion forum, among other examples.

As shown in FIG. 4, the process 400 includes sending a notification to the users included in the asynchronous audio discussion forum (block 410). As an example, after the user has provided the relevant information for the asynchronous audio discussion forum, each user may receive a notification that the asynchronous audio discussion forum was created. In some implementations, this notification may provide access to the user and may indicate whether the user has a speaker status or a non-speaker status, as described in more detail elsewhere herein.

In some implementations, the notification may be a text message, an email, a pop-up icon associated with the client application, a sound, a haptic, or other form of notification sufficient to let the user know the user has been included in the asynchronous audio discussion forum, among other examples. Although a user may be invited to join the asynchronous audio discussion forum, the user may decline the invitation, may listen to one or more voice entries, and/or may provide one or more voice entries (e.g., depending on whether the user has a speaker status or a non-speaker status).

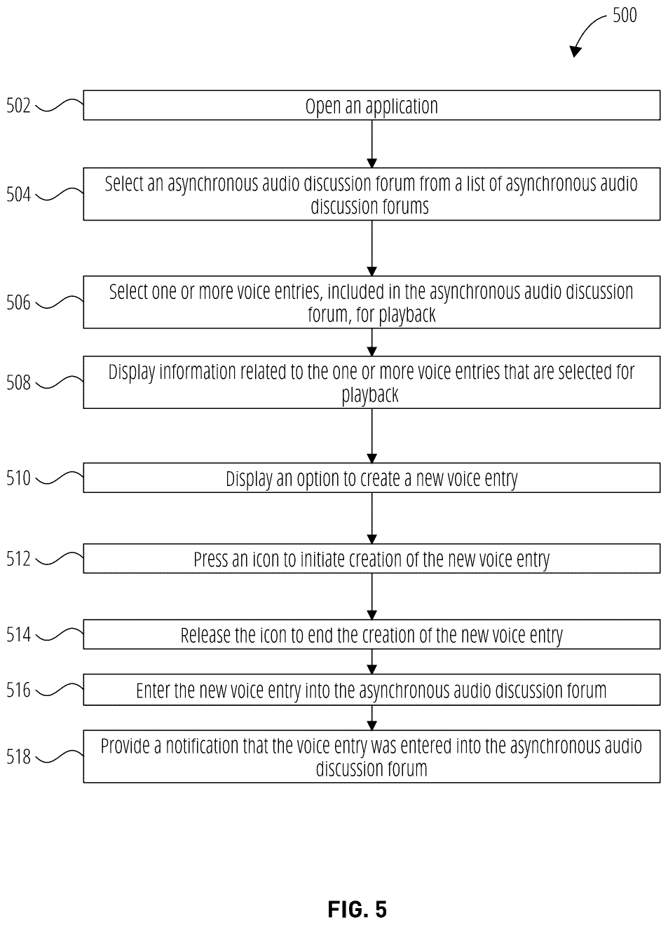

FIG. 5 is a flowchart of an example process 500 associated with asynchronous audio discussions. In some implementations, the process 500 may be implemented via the audio processing architecture 300 of FIG. 3. As shown in FIG. 5, the process 500 includes opening an application (block 502). As an example, the user may open a client application (e.g., the first user 19a may use the first user device 116a to open the first application 118a).

As shown in FIG. 5, the process 500 includes selecting an asynchronous audio discussion forum from a list of asynchronous audio discussion forums (block 504). As an example, with the client application open, the user may be presented with a list of asynchronous audio discussion forums to which the user has access. The list may be presented through the user interface of the client application with identification information associated with each asynchronous audio discussion forum including a time that each asynchronous audio discussion forum was created. As an example, the identification information may include an icon or picture, a title of the asynchronous audio discussion forum, an indication of who created the asynchronous audio discussion forum, a time and a date when the asynchronous audio discussion forum was created, a time and a date that the latest voice entry was entered, and/or any other relevant information for identifying the asynchronous audio discussion forum, among other examples.

In some implementations, the user interface of the client application may display relevant information about the selected asynchronous audio discussion forum (e.g., as described in more detail elsewhere herein). Additionally, or alternatively, the user interface may present information identifying each user included in the asynchronous audio discussion forum (e.g., each user that has access to the asynchronous audio discussion forum), a list of existing voice entries (e.g., based on the voice entries being previously entered), and/or an icon or button for creating a voice entry (e.g., by providing the voice data via a microphone of the user device, as described in more detail elsewhere herein).

As an example, the information identifying each user may include icons or pics of each user, text information providing a name of the user, and/or a status of the user (e.g., a speaker status or a non-speaker status, among other examples). As another example, the list of existing voice entries may include information identifying which user created the voice entry, a time and date that the voice entry was created, a time and a date that the voice entry was entered into the asynchronous audio discussion forum, and/or a duration or a length of the voice entry, among other examples.

As shown in FIG. 5, the process 500 includes selecting one or more voice entries, included in the asynchronous audio discussion forum, for playback (block 506). The one or more voice entries (e.g., selected by the user) may be played back in any suitable manner. As an example, the one or more voice entries may be sequentially played back so as to emulate a live conversation. To trigger this play back process, the one or more voice entries (e.g., selected by the user) may include all existing voice entries, and the one or more voice entries may be played back beginning with a first entered voice entry and ending with a last entered voice entry.

As another example, the one or more voice entries (e.g., selected by the user) nay include a portion of the existing voice entries, such as a first voice entry, a last voice entry, and/or a voice entry entered after a latest played back voice entry, among other examples. In other words, the client application may playback all voice entries from first entered to last entered or from the voice entry after last voice entry previously heard to the last entered voice entry. Additionally, or alternatively, the user may select a speed at which to play back the one or more voice entries (e.g., a real-time speed, a 1.5× speed, and/or a 2× speed, among other examples).

As shown in FIG. 5, the process 500 includes displaying information related to the one or more voice entries that are selected for playback (block 508). As an example, the client application may display information that identifies a creator of the one or more voice entries and/or playback timing information (e.g., an elapsed time of playback or a current playback position), among other examples).

In some implementations, the user interface of client application may provide an indication of the elapsed time of a voice entry that is currently being played back and the creator the voice entry that is currently being played back. As an example, the user interface may highlight an icon or image associated with the creator of the voice entry (e.g., a circle may be provided that surrounds the icon or image associated with the creator of the voice entry). Additionally, or alternatively, the user interface may provide a visual indication that illustrates a position of the currently played voice entry relative to other voice entries (e.g., the one or more voice entries may be presented temporally along a timeline) and/or may change a visual indication to illustrate how much of the voice entry has been played back and how much of the voice entry remains to be played back. After the last voice entry (e.g., the last selected voice entry or the last voice entry entered into the asynchronous audio discussion forum, among other examples), the user may create a new voice entry, as described in more detail elsewhere herein.

As shown in FIG. 5, the process 500 includes displaying an option to create a new voice entry (block 510). As an example, the user interface may display an icon (e.g., a record button), which the user may use to provide new voice data for the new voice entry.

As shown in FIG. 5, the process 500 includes pressing an icon to initiate creation of the new voice entry (block 512). As an example, the user may press and hold the icon to provide the voice data (e.g., via a microphone of the user device).

As shown in FIG. 5, the process 500 includes releasing the icon to end the creation of the new voice entry (block 514). As an example, the user may release the icon to end recording of the voice data. The voice data may be stored in a database and/or may be entered into the asynchronous audio discussion forum for playback, as described in more detail elsewhere herein.

As shown in FIG. 5, the process 500 includes entering the new voice entry into the asynchronous audio discussion forum (block 516). In some implementations, the client application may generate the new voice entry based on the new voice data and may enter the new voice entry into the asynchronous audio discussion forum.

As shown in FIG. 5, the process 500 includes providing a notification that the voice entry was entered into the asynchronous audio discussion forum (block 518). As an example, the client application may provide a notification to users included in the asynchronous audio discussion forum (e.g. other than the user who created the new voice entry) that the new voice entry has been entered into the asynchronous audio discussion forum. As an example, the notification may be a text message, an email, a pop-up icon associated with the client application, a sound, a haptic, or other form of notification sufficient to let the user know that a new voice entry has been entered in the asynchronous audio discussion forum, among other examples. Accordingly, after the new voice entry is entered into the asynchronous audio discussion forum, each user included in the asynchronous audio discussion forum may receive a notification of the new voice entry.

In some implementations, the notification may also provide an input option (e.g., a button, icon, or a hyperlink, among other examples) that a user selects to automatically initiate the client application and cause playback of the new voice entry. Thus, for example, if a user selects the input option (e.g., by selecting the button, the icon, or the hyperlink), the client application may automatically open, and the client application may begin playback of new voice entry. Additionally, or alternatively, the client application may be configured (e.g., by the user) to playback new voice entries, all voice entries, and/or unheard voice entries as desired, among other examples.

In some implementations, the recorder 322 may store (e.g., in the audio room database 324) the voice entries for retrieval by users included in the asynchronous audio discussion forum. Additionally, or alternatively, the recorder 322 may store (e.g., in the audio room database 324) the data and/or the metadata associated with the voice entries and/or the asynchronous audio discussion forum (e.g., as described in more detail elsewhere herein) for retrieval by users included in the asynchronous audio discussion forum. In some implementations, the data and/or the metadata enables the audio processing architecture 300 to be responsive to user input (e.g., responses and/or requests, among other examples) from users having access to the asynchronous audio discussion forum, which enables the audio processing architecture 300 to provide appropriate voice entries for playback (e.g., based on the user input).

The processes for creating asynchronous audio discussion forums, creating new voice entries, and listening to voice entries as described above with respect to FIGS. 4-5, and/or as described in more detail elsewhere herein, may be modified in various ways. For example, the names associated with an asynchronous audio discussion forum may be created automatically based on an automated transcription of content in the voice entries of the asynchronous audio discussion forum. The asynchronous audio discussion forum names may also be modified by users in the asynchronous audio discussion forum as desired, such as by presenting an option in the user interface of the client application that is selected by the user to enter a new title. That title may be limited to the one presented to that particular user or may be applied to all users in the asynchronous audio discussion forum.

In some implementations, users may use an existing voice entry from an existing asynchronous audio discussion forum to start a new asynchronous audio discussion forum. As part of creating a new asynchronous audio discussion forum, the process of FIG. 5 may include an option for a user to “quote” an existing voice entry and use it as a starting point for a new asynchronous audio discussion forum. To “quote”, the user may select one or more voice entries to include as initial voice entries included in the new asynchronous audio discussion forum. The user interface for the client application may also present an icon or button while a user plays a voice entry that, if selected, starts the creation of a new asynchronous audio discussion forum with the currently playing voice entry as an initial entry in the new asynchronous audio discussion forum.

In some implementations, the user may select a portion or segment of a voice entry (e.g., rather than an entirety of the voice entry). In some implementations, rather than including a quoted voice entry as the initial entry in the new asynchronous audio discussion forum, the new asynchronous audio discussion forum may include a reference to the quoted voice entry that allows the quoted voice entry to be accessed or played back or may display a text transcription of the quoted voice entry while a new voice entry is played back.

In addition to providing voice entries in an asynchronous audio discussion forum, users may share a “link” or an image (e.g., a photo or picture). The shared link or image may be used to start a new asynchronous audio discussion forum, may be used to reply to an existing voice entry, and/or may be used to annotate a voice entry. In some implementations, the user interface for the client application may include a button or icon that the user selects, and the user interface then presents a location through which the user can select the link or image to include as a reply or to start a new asynchronous audio discussion forum, among other examples. Additionally, or alternatively, users may provide the link or the image in association with one or more voice entries included in an asynchronous audio discussion forum.

In some implementations, users may communicate directly (e.g., via voice entries) with other users. The user interface may display a log of users that have recently communicated directly with other users. In this way, users may interact with the log of users to create one or more asynchronous audio discussion forums.

While the above processes are configured to accommodate asynchronous discussions among users having access to asynchronous audio discussion forums, the audio processing architecture 300 may be configured to transition to a live conversation between two or more users within the asynchronous audio discussion forum (e.g., when those users are online at the same time). The user interface for the client application may include a button or icon that the user selects, and the user interface then presents an indication of which users are online. The user then selects one or more of the users that are online, and, in response, a live voice discussion may be started among those users.

Moreover, the live conversation may be recorded and stored as one or more voice entries in the existing asynchronous audio discussion forum so that other users in the asynchronous audio discussion forums may playback the one or more voice entries. For each voice entry in an asynchronous audio discussion forum, the user interface for the client application may display a caption associated with a voice entry. The caption may be created by a user that created the voice entry and may provide a brief description of the content of the voice entry. Additionally, or alternatively, a caption may be generated automatically based on an automated transcription of the content of the voice entry.

In some implementations, the system may use one or more artificial intelligence (AI) techniques to process the voice entries (e.g., the audio content of the voice entries). As an example, the system may use an automatic speech recognition (ASR) technique to generate a transcription of the voice entries and/or a natural language process (NLP) technique to generate conversation summaries associated with the voice entries (e.g., a conversation summary of all voice entries included in an asynchronous audio discussion forum).

In some implementations, the client application may include features that enable users to navigate content of one or more voice entries via a transcription. As an example, the client application may present (via the user interface) a transcript view including a “scrub” chat bar. The user may interact with the scrub chat bar to navigate the content of the one or more voice entries.

In some implementations, the organization of voice entries in an asynchronous audio discussion forum may be altered. For example, an asynchronous audio discussion forum may be stated based on a particular prompt, question, or issue, among other examples. Users in the asynchronous audio discussion forum may make voice entries based on the prompt, question, or issue, among other examples. As users in the asynchronous audio discussion forum listen to the responsive voice entries, each user can give each voice entry a ranking or rating. Alternatively, ratings or rankings may be inferred based on user engagement with the voice entries (e.g. a higher rating may be inferred for voice entries that are fully listened to or responded to, among other examples). As the ratings or rankings for voice entries accumulate, an ordering of the voice entries in the asynchronous audio discussion forum may be altered away from chronology and instead listed or presented in the order of their rankings or ratings with voice entries having the highest rankings or ratings listed earlier. In this way, users may listen to the best responses first. Users may also provide reactions to any particular voice entry in an asynchronous audio discussion forum.

In some implementations, the reactions may be “likes”, “loves”, emojis, texts or other indication of feelings of the users about the voice entry, among other examples. The creator of the voice entry may receive a notification about the reaction. In addition, other users may see the reaction in the user interface of the client application when listening to that voice entry.

In addition to recording and tracking voice entries made in an asynchronous audio discussion forum, the audio processing architecture 300 may track which users have listened to each voice entry. That information can be stored in the audio room database 324. In addition, the user interface for the client application can be configured to list which users have listed to the voice entry (e.g., as a user listens to the voice entry).

As some asynchronous audio discussion forums and/or voice entries may become stale, the audio processing architecture 300 may delete or hide an asynchronous audio discussion forum (e.g., under certain circumstances). For example, if no user has provided a new voice entry to the asynchronous audio discussion forum after a certain period of time, then the audio processing architecture 300 may automatically delete the asynchronous audio discussion forum or hide it from view after that period of time has elapsed since the last new voice entry. As a default, each user in an asynchronous audio discussion forum may both listen to voice entries and create their own voice entries. Asynchronous audio discussion forums may also be configured to provide different permissions. For example, a user can be designated solely as a listener with the ability to create voice entries disabled. Accordingly, in some implementations, users may participate based on a permission status (or permission level) related to the asynchronous audio discussion forum.

As a shortcut to starting a one-on-one discussion, the user interface of the client application may be configured so that tapping on, or continuously touching, a picture or icon of a user automatically creates a one-on-one discussion with that user. That one-on-one discussion may be a private room restricted to those two users. Alternatively, the room may be an open room in which those two users can select other users to join.

In a default process for creating a new voice entry, the user waits until hearing all voice entries (or all unheard voice entries) in the asynchronous audio discussion forum before having the option of creating a new voice entry. Instead, a user may also be provided with an option to reply or react with a new voice entry before all voice entries have been played back. In this way, users may be to hear that new voice entry at an appropriate time, such as a time where one user laughs at a voice entry of another user.

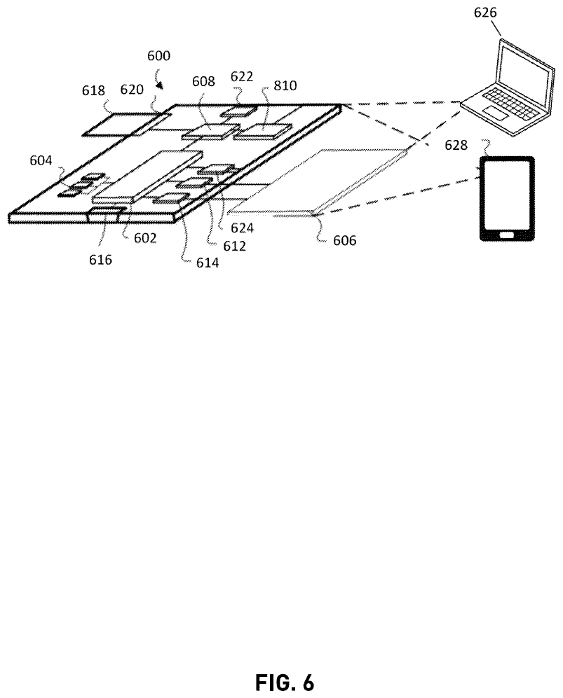

FIG. 6 shows an example of a computing device 600 (e.g., a computer). The computing device 600 includes a processor 602, memory 604, an input/output device (e.g., shown as a display 606 in FIG. 6), a communication interface 608, and a transceiver 610. The computing device 600 may also include a storage device, such as a micro-drive or other device, to provide additional storage. Each of the components of the computing device 600 (e.g., the processor 602, the memory 604, the display 606, the communication interface 608, and the transceiver 610, are interconnected using various buses, and several of the components may be mounted on a common motherboard or in other manners as appropriate.

The processor 602 may execute instructions within the computing device 600, including instructions stored in the memory 604. The processor 602 may be implemented as a chipset of chips that include separate and multiple analog and digital processors. The processor 602 may provide, for example, for coordination of the other components of the device 600, such as control of user interfaces, applications run by device 600, and/or wireless communication by device 600, among other examples.

The processor 602 communicates with a user through a control interface 612 and a display interface 614 coupled to the display 606. The display 606 may be, for example, a thin-film-transistor liquid crystal display (TFT LCD) or an organic light emitting diode (OLED) display, or other appropriate display technology, among other examples. The display interface 614 may include appropriate circuitry for driving the display 606 to present graphical and other information to a user. The control interface 612 may receive commands from a user (e.g., via a user input) and convert the commands for submission to the processor 602. Additionally, an external interface 616 may be provided in communication with processor 602, to enable near area communication of the computing device 600 with other devices. The external interface 616 may provide, for example, for wired communication in some implementations, or for wireless communication in other implementations, and multiple interfaces may also be used.

The memory 604 stores information within the computing device 600. The memory 604 may be implemented as one or more of a computer-readable medium or media, a volatile memory unit or units, or a non-volatile memory unit or units. Expansion memory 618 may also be provided and connected to computing device 600 through an expansion interface 620, which may include, for example, a single in-line memory module (SIMM) card interface. The expansion memory 618 may provide extra storage space for the computing device 600 and/or may also store applications or other information for the computing device 600. As an example, the expansion memory 618 may include instructions to carry out or supplement the processes described above and may include secure information. Thus, for example, the expansion memory 618 may be provided as a security module for the computing device 600 and may be programmed with instructions that permit secure use of the computing device 600. Additionally, secure applications may be provided via a SIMM card, along with additional information, such as placing identifying information on the SIMM card in a non-hackable manner.

The memory 604 may include, for example, flash memory and/or NVRAM memory, as described in more detail elsewhere herein. In some implementations, a computer program product is tangibly embodied in an information carrier. The computer program product contains instructions that, when executed, perform one or more processes and/or methods, such as those described in more detail elsewhere herein. An information carrier may be a computer or a machine-readable medium, such as the memory 604, expansion memory 618, memory on the processor 602, or a propagated signal that may be received, for example, over transceiver 610 or the external interface 616. The computing device 600 may communicate wirelessly through the communication interface 608, which may include digital signal processing circuitry where necessary. The communication interface 608 may in some cases be a cellular modem.

The communication interface 608 may provide for communications under various modes or protocols, such as GSM voice calls, SMS, EMS, or NNs messaging, CDMA, TDMA, PDC, WCDMA, CDMA2000, or GPRS, among others. Such communication may occur, for example, through the transceiver 610 (e.g., a radio-frequency (RF) transceiver). Additionally, short-range communication may be used, such as by using a Bluetooth, Wi-Fi, or other such transceiver (not shown). Furthermore, a global positioning system, (GPS) receiver module 622 may provide additional navigation and location related wireless data to the computing device 600, which may be used as appropriate by applications running on the computing device 600.

The computing device 600 may communicate audibly using an audio codec 624, which may receive spoken information from a user and convert it to usable digital information. The audio codec 624 may likewise generate audible sound for a user, such as through a speaker (e.g., of a handset of the computing device 600, among other examples). Such sound may include sound from voice telephone calls, may include recorded sound (e.g., voice data and/or music files, among other examples) and may also include sound generated by applications operating on the computing device 600. In some implementations, the computing device 600 may include a microphone to collect audio (e.g., speech) from a user. Likewise, the computing device 600 may include an input to receive a connection from an external microphone.

The computing device 600 may be implemented in a number of different forms. For example, the computing device 600 may be implemented as a computer 626 (e.g., a laptop, among other examples). As another example, the computing device 600 may be implemented as part of a smartphone 628, a smart watch, a tablet, a personal digital assistant, and/or another similar mobile device, among other examples.

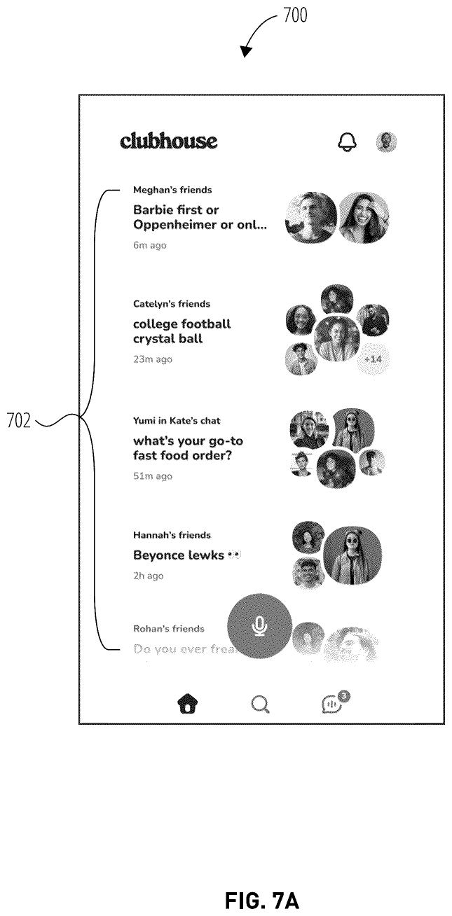

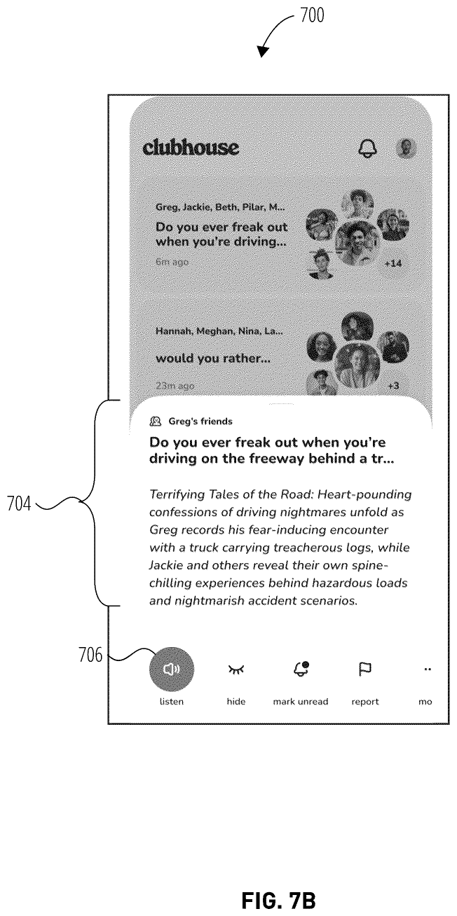

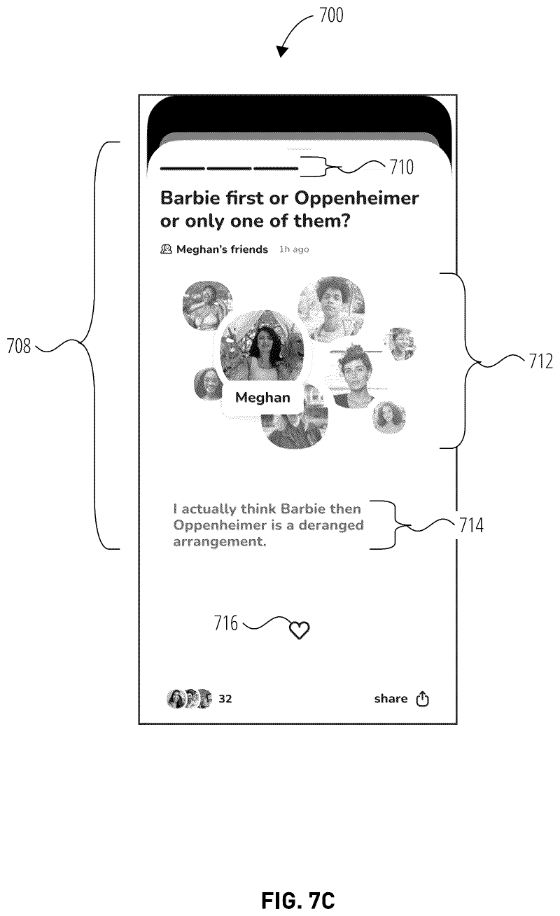

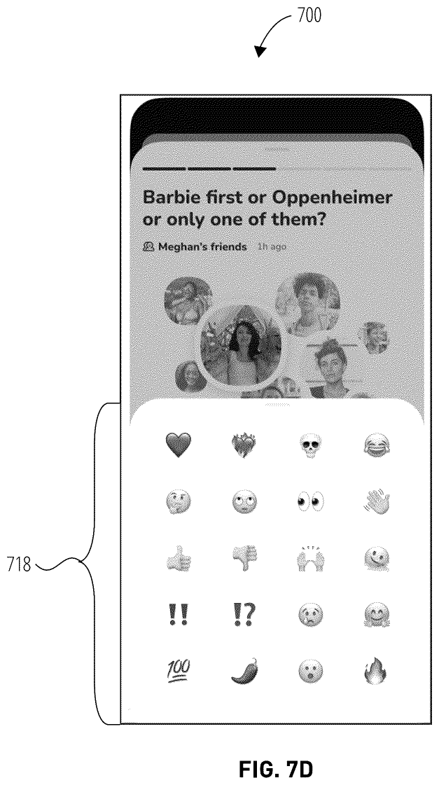

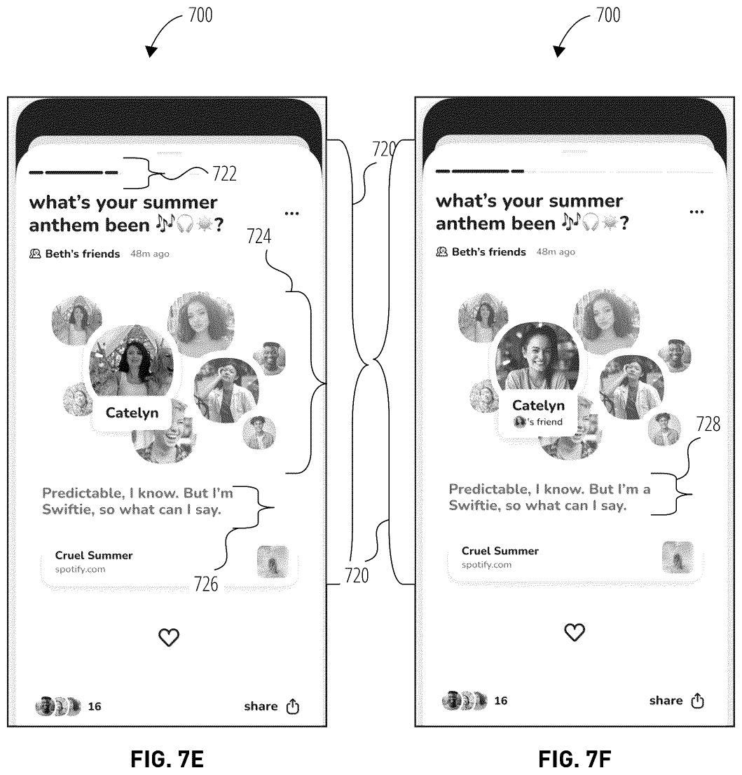

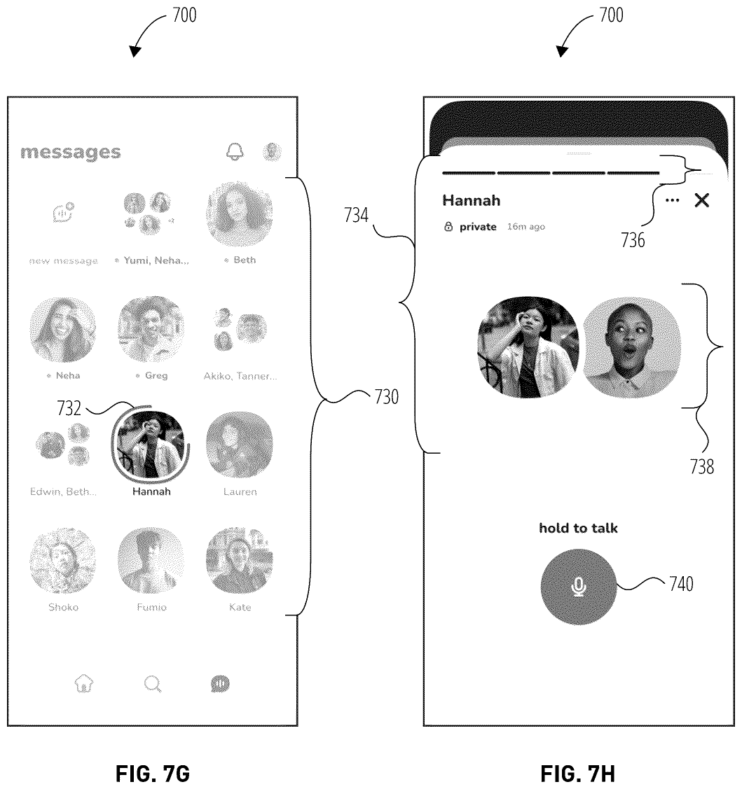

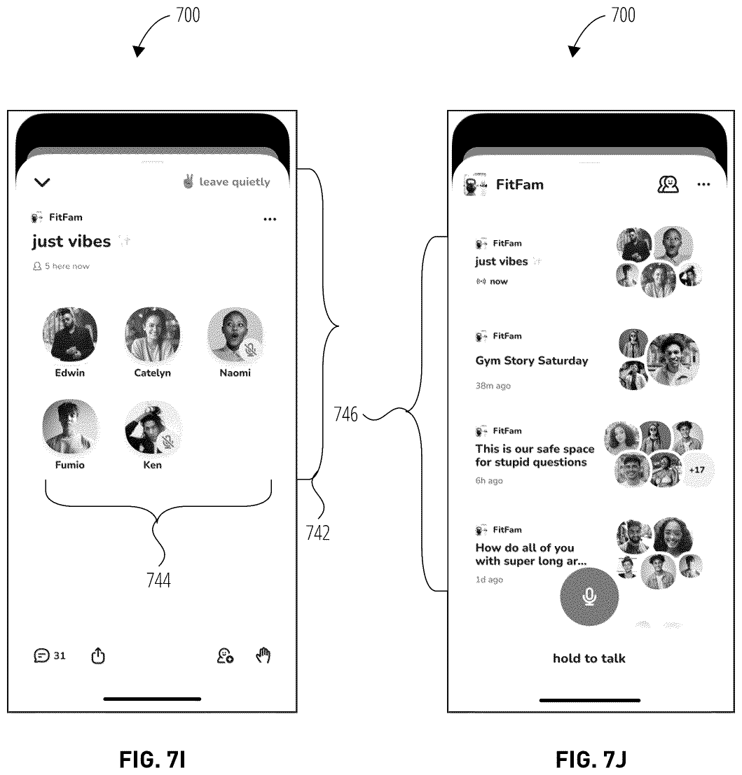

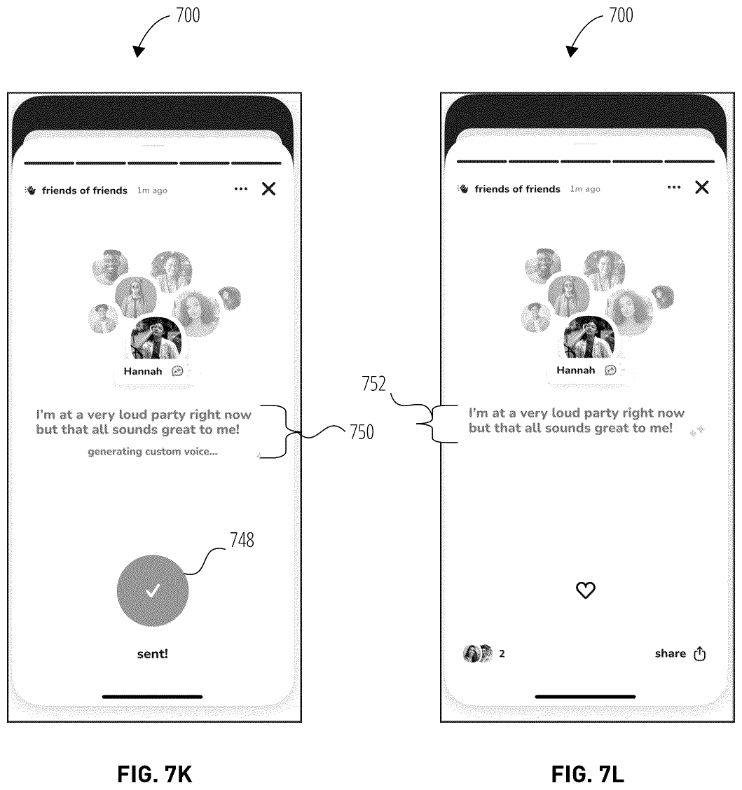

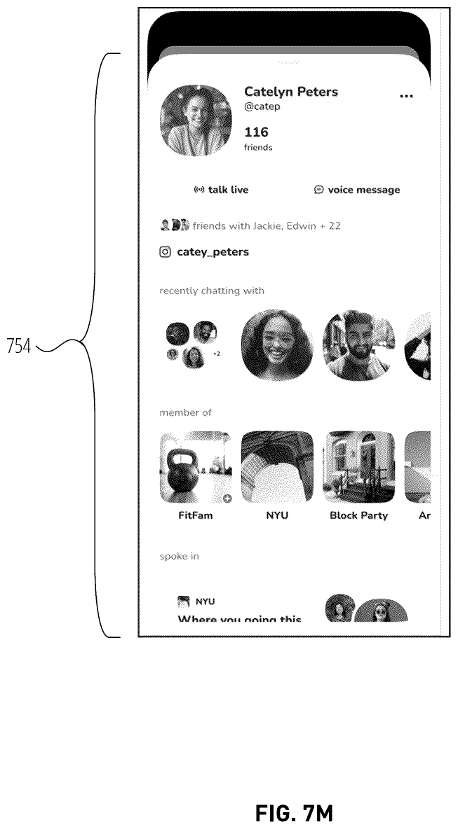

FIGS. 7A-7M are diagrams of an example user interface 700 (e.g., which may correspond to the first user interface 120a of the first user device 116a of the first user 19a) associated with asynchronous audio discussion forums. In some implementations, the user interface 700 may be provided via a client application executing on a user device (e.g., which may correspond to the first client application 118a executing on the first user device 116a).

As shown in FIG. 7A, the user interface 700 displays a list of asynchronous audio discussion forums 702. The list of asynchronous audio discussion forums 702 includes information related to multiple asynchronous audio discussion forums and corresponding information (e.g., user information). The list of asynchronous audio discussion forums 702 may be presented to a user having access to each of the asynchronous audio discussion forums included in the list of asynchronous audio discussion forums 702. The user may join an asynchronous audio discussion forum (e.g., by clicking on the asynchronous audio discussion forum).

As shown in FIG. 7B, the user interface 700 displays a first asynchronous audio discussion forum 704 (e.g., an asynchronous audio discussion forum selected by the user) and a listen input option 706. The first asynchronous audio discussion forum 704 includes a voice entry that the user may listen to (e.g., by pressing the listen input option 706).

As shown in FIG. 7C, the user interface 700 displays a second asynchronous audio discussion forum 708. The second asynchronous audio discussion forum 708 indicates a first set of voice entries 710, a first set of users 712 (e.g., having access to the second asynchronous audio discussion forum 708), and a first voice entry 714 that is currently being played back. The first set of voice entries 710 are represented as line segments (e.g., horizontal line segments) having lengths that are proportional to durations of the voice entries included in the first set of voice entries 710. The user interface 700 includes a first reaction input option 716 (e.g., shown as a heart emoji in FIG. 7C) that the user may press to represent a reaction of the user. The user interface 700 may include a set of reaction input options 718 (e.g., shown as a set of emojis in FIG. 7D) from which the user may select (e.g., to indicate a reaction of the user).

As shown in FIG. 7E, the user interface 700 displays a third asynchronous audio discussion forum 720. The third asynchronous audio discussion forum 720 indicates a second set of voice entries 722, a second set of users 724 (e.g., having access to the third asynchronous audio discussion forum 720), and a second voice entry 726 that is currently being played back (e.g., shown as corresponding to a particular user). As shown in FIG. 7F, the third asynchronous audio discussion forum indicates a third voice entry 728 that is currently being played back (e.g., shown as corresponding to a different particular user).

As shown in FIG. 7G, the user interface 700 displays multiple identifiers 730 (e.g., images) corresponding to multiple users. The user may select an identifier, of the multiple identifiers 730, corresponding to a user to initiate an asynchronous audio discussion forum with that user (e.g., shown as a selected identifier 732 in FIG. 7G).

As shown in FIG. 7H, the user interface 700 displays a fourth asynchronous audio discussion forum 734. The fourth asynchronous audio discussion forum 734 indicates a third set of voice entries 736, a third set of users 738 (e.g., having access to the fourth asynchronous audio discussion forum 734), and a voice entry input option 740. The user may create a voice entry by interacting with the voice entry input option 740 (e.g., by pressing, holding, and releasing the voice entry input option 740).

As shown in FIG. 7I, the user interface 700 displays an asynchronous audio discussion group 742 including a group of users 744. As shown in FIG. 7J, the asynchronous audio discussion group 742 may include multiple asynchronous group audio discussion forums 746.

As shown in FIG. 7K, the user interface 700 displays a text-to-speech voice generation input option 748. The user may provide a text-based input 750 that is translated into voice data to create a voice entry that emulates a voice (e.g., a voice of the user or an artificially generated voice), as described in more detail elsewhere herein. After the text-based input is translated into the voice data, the voice data may be entered as a text-based voice entry 752 that is based on the text-based input 750 (e.g., as shown in FIG. 7L).

As shown in FIG. 7M, the user interface 700 displays a user profile 754. The user profile 754 may include any suitable user information, as described in more detail elsewhere herein.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs (e.g., one or more modules of computer program instructions, encoded on computer storage medium for execution by, or to control the operation of, data processing apparatus).

Additionally, or alternatively, the program instructions may be encoded on an artificially generated propagated signal (e.g., a machine-generated electrical, optical, or electromagnetic signal), that is generated to encode information for transmission to a suitable receiver apparatus for execution by a data processing apparatus. A computer storage medium may be, or may be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks (e.g., internal hard disks or removable disks, magneto-optical disks, and/or CD-ROM and DVD-ROM disks, among other examples). The processor and the memory can be supplemented by, or incorporated in, special purpose logic circuitry. To provide for interaction with a user, implementations of the subject matter described in this specification can be implemented on a computer having a display device (e.g., a CRT (cathode ray tube) or a LCD (liquid crystal display) monitor, among other examples) for displaying information to the user and a keyboard and a pointing device (e.g., mouse or a trackball, among other examples) by which the user can provide input to the computer. Other kinds of devices can be used to provide for interaction with a user as well; for example, feedback provided to the user can be any form of sensory feedback (e.g., visual feedback, auditory feedback, and/or tactile feedback, among other examples) and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser. Implementations of the subject matter described in this specification can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the subject matter described in this specification), or any combination of one or more such back-end, middleware, or front-end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
generating, by a device, an asynchronous audio discussion forum,
wherein a set of users has access to the asynchronous audio discussion forum;
receiving, by the device and at a first time, first voice data;
receiving, by the device and at a second time that is later than the first time, second voice data;
generating, by the device, a first voice entry based on the first voice data and a second voice entry based on the second voice data; and
providing, by the device and within the asynchronous audio discussion forum, the first voice entry and the second voice entry for playback by one or more users included in the set of users.

2. The method of claim 1, further comprising:
receiving, by the device and at a third time that is later than the second time, third voice data;
generating, by the device, a third voice entry based on the third voice data; and
providing, by the device and within the asynchronous audio discussion forum, the third voice entry for the playback by the one or more users included in the set of users,
wherein the third voice entry is responsive to at least one of:
the first voice entry, or
the second voice entry.

3. The method of claim 1, wherein generating, by the device, the asynchronous audio discussion forum comprises:
receiving, by the device, a request to generate the asynchronous audio discussion forum,
wherein the request includes an indication of the set of users with the access to the asynchronous audio discussion forum.

4. The method of claim 1, further comprising:
assigning, by the device, a speaker permission status to a first subset of users, included in the set of users, and a listener permission status to a second subset of users, included in the set of users,
wherein the first subset of users are authorized to provide voice data for the asynchronous audio discussion forum, and
wherein the second subset of users are not authorized to provide the voice data for the asynchronous audio discussion forum.

5. The method of claim 1, further comprising:
identifying, by the device and within the asynchronous audio discussion forum, a duration of at least one of the first voice entry or the second voice entry.

6. The method of claim 1, further comprising:
receiving, by the device, a playback request to playback at least one of the first voice entry or the second voice entry; and
causing, by the device and based on the playback request, the at least one of the first voice entry or the second voice entry to begin playback; and
identifying, by the device, a current playback position of the at least one of the first voice entry or the second voice entry.

7. The method of claim 1, further comprising:
generating, by the device, a first transcription based on the first voice entry and a second transcription based on the second voice entry; and
providing, by the device and within the asynchronous audio discussion forum, the first transcription proximate the first voice entry and the second transcription proximate the second voice entry.

8. A system, comprising:
one or more memories; and
one or more processors, communicatively coupled to the one or more memories, configured to:
provide a set of users with access to an asynchronous audio discussion forum;
receive first voice data at a first time;
receive second voice data at a second time that is later than the first time;
generate a first voice entry based on the first voice data and a second voice entry based on the second voice data; and
provide, within the asynchronous audio discussion forum, the first voice entry and the second voice entry for playback by one or more users included in the set of users.

9. The system of claim 8, the one or more processors, to provide the set of users with the access to the asynchronous audio discussion forum, are configured to:
receive a request to generate the asynchronous audio discussion forum,
wherein the request indicates the set of users with the access to the asynchronous audio discussion forum;
generate, based on the request, the asynchronous audio discussion forum; and
provide a notification to the set of users indicating that the asynchronous audio discussion forum has been generated and that the set of users have been provided with the access to the asynchronous audio discussion forum.

10. The system of claim 8, wherein the one or more processors are configured to:
receive a playback request for at least one of the first voice entry or the second voice entry;
enable, based on the playback request, playback of the at least one of the first voice entry or the second voice entry;
receive third voice data;
generate a third voice entry based on the third voice data,
wherein the third voice entry is responsive to the at least one of the first voice entry or the second voice entry; and
provide, within the asynchronous audio discussion forum, the third voice entry for the playback by the one or more users included in the set of users.

11. The system of claim 8, wherein the one or more processors are configured to:
provide a notification to the set of users that the first voice entry and the second voice entry have been provided within the asynchronous audio discussion forum for playback.

12. The system of claim 8, wherein the one or more processors are configured to:
assign a speaker permission status to a first subset of users, included in the set of users, and a listener permission status to a second subset of users, included in the set of users,
wherein the first subset of users are authorized to provide voice data for the asynchronous audio discussion forum and are authorized to playback at least one of the first voice entry or the second voice entry; and
wherein the second subset of users are not authorized to provide the voice data for the asynchronous audio discussion forum but are authorized to listen to the at least one of the first voice entry or the second voice entry.

13. The system of claim 8, wherein the one or more processors are configured to:
identify, within the asynchronous audio discussion forum, users, included in the set of users, that provided the first voice data for the first voice entry and the second voice data for the second voice entry.

14. The system of claim 8, wherein the one or more processors are configured to:
identify, within the asynchronous audio discussion forum, a current status of the set of users.

15. A non-transitory computer-readable medium storing a set of instructions, the set of instructions comprising:
one or more instructions that, when executed by one or more processors of an asynchronous audio discussion system, cause the asynchronous audio discussion system, to:
provide a set of users with access to an asynchronous audio discussion forum;
receive first voice data at a first time;
receive second voice data at a second time that is later than the first time;
generate a first voice entry based on the first voice data and a second voice entry based on the second voice data; and
provide, within the asynchronous audio discussion forum, the first voice entry and the second voice entry for playback by one or more users included in the set of users.

16. The non-transitory computer-readable medium of claim 15, wherein the one or more instructions, that cause the asynchronous audio discussion system to provide the set of users with the access to the asynchronous audio discussion forum, cause the asynchronous audio discussion system to:
receive a request to generate the asynchronous audio discussion forum,
wherein the request indicates the set of users with the access to the asynchronous audio discussion forum;
generate, based on the request, the asynchronous audio discussion forum; and
provide a notification to the set of users indicating that the asynchronous audio discussion forum has been generated and that the set of users have been provided with the access to the asynchronous audio discussion forum.

17. The non-transitory computer-readable medium of claim 15, wherein the one or more instructions cause the asynchronous audio discussion system to:
receive a playback request for at least one of the first voice entry or the second voice entry;
enable, based on the playback request, playback of the at least one of the first voice entry or the second voice entry;
receive third voice data;
generate a third voice entry based on the third voice data,
wherein the third voice entry is responsive to the at least one of the first voice entry or the second voice entry; and
provide, within the asynchronous audio discussion forum, the third voice entry for the playback by the one or more users included in the set of users.

18. The non-transitory computer-readable medium of claim 15, wherein the one or more instructions cause the asynchronous audio discussion system to:
provide a notification to the set of users that the first voice entry and the second voice entry have been provided within the asynchronous audio discussion forum for playback.

19. The non-transitory computer-readable medium of claim 15, wherein the one or more instructions cause the asynchronous audio discussion system to:
assign a speaker permission status to a first subset of users, included in the set of users, and a listener permission status to a second subset of users, included in the set of users,
wherein the first subset of users are authorized to provide voice data for the asynchronous audio discussion forum and are authorized to playback at least one of the first voice entry or the second voice entry; and
wherein the second subset of users are not authorized to provide the voice data for the asynchronous audio discussion forum but are authorized to listen to the at least one of the first voice entry or the second voice entry.

20. The non-transitory computer-readable medium of claim 15, wherein the one or more instructions cause the asynchronous audio discussion system to:
identify, within the asynchronous audio discussion forum, users, included in the set of users, that provided the first voice data for the first voice entry and the second voice data for the second voice entry.
